(19) United States
(12) Patent Application Publication
(10) Pub. No.: US 2009/0055869 A1
(43) Pub. Date: Feb. 26, 2009

(54) Method for Controlling Video Content Display and Display and Computer Readable Medium with Embedded OSD which the Method Disclosed

(76) Inventors: Jenn-Shoou Young, Hsinchu Science Park (CN); Sheng-Yuan Huang, Hsinchu Science Park (CN)

Correspondence Address: HDLS Patent & Trademark Services, P.O. BOX 220746, CHANTILLY, VA, 20153-0746, US

(21) Appl. No.: 12/052,996

(22) Filed: Mar. 21, 2008

(30) Foreign Application Priority Data
Aug. 24, 2007 (TW) 096131358

(51) Int. Cl. H04N 5/445

(52) U.S. Cl. 725/42

(57) ABSTRACT

In a method for controlling video content display and a display and a computer readable medium, the method accomplishes the video display control through setting the corresponding parameter value of a video display control item in an on screen display of the display, and the video includes a first video content such as an image and a second video content such as a subtitle. Accordingly, the display device completes the video display control directly and quiet straightforward.

### BACKGROUND

The present invention relates to a video content display technique, and more specifically, the present invention discloses a method, a display and a computer readable medium for video content display control in an on screen display (OSD).

The firms that wish to promote their product with advertisement always implement the content by themselves or just commission an advertisement vendor to do that for them. Before showing the advertisement, it needs digital signage display system and management software interface for displaying and scheduling. As shown in FIG. 1, the digital signage display system 1 consists of a client terminal 11, a server 12, a digital signage box 13 and a display 141 or 142. The server 12 receives and combines a video content 161 and a subtitle 162 of client terminal 11 to form a video displayed in the display 141 or 142 later, characters such as source 151, special effects 152, font 153, size 154 and color 155 are set in the management software interface 15. The mentioned advertisement updates the content of the digital signage box 13 and then is displayed in one of the display 141 and 142, such as a computer monitor, a TV and advertisement player in public place, or even in a public display system consisting of more display 141 and 142. However, it increases the costs in system environment establishing and maintaining, and goes to the expense of affording the training fee and salary of system administrator. More, it also results in the indirect update and late response since the firm should inform the advertisement vendor for further parameter adjustment in the management software interface 15.

As shown in FIG. 2, an OSD 20 of a display 2 has a brightness adjustment item 211, a contrast adjustment item 212, a screen adjustment item 213, an OSD setting item 214 and miscellaneous adjustment item 215. A corresponding advanced item and an inputting zone of parameter value will pop up when a user selects one of the mentioned items. For instance, an OSD horizontal position adjustment item 221, an OSD vertical position adjustment item 222 and an OSD language setting item 223 will be displayed for receiving the parameter value sent from an input device such as remote controller when the user select the OSD setting item 214. Unfortunately, it still lacks of a direct way for user to perform the video content display control.

Accordingly, the ordinary digital signage display system is controlled by an external and remote interface for parameter adjusting of the video content such as subtitle, and the content storing, updating and distributing should be done by equipping with an external sever box or a media box. It really increases the costs in many aspects and lacks of flexibility.

### BRIEF SUMMARY

The present invention is to provide a method, a display and a computer readable medium for video content display control in an OSD.

According to one preferred embodiment of the present invention, a method for controlling video content display for accomplishing display control of a video consisting of a first and a second video content in a display directly is disclosed. The method includes the steps of providing a video display control item in an OSD of the display, operating the OSD and selecting the video display control item, and setting a corresponding parameter value of a parameter of the video display control item such as a display position, a switch effect and a transparency to adjust the first and the second video content.

According to another preferred embodiment of the present invention, a display with video content display control is disclosed. The display includes an OSD having a video display control item for setting display control of a video consisting of a first and a second video content. Thus it may achieve the goal of video control display control more easily and directly and cost down.

According to one preferred embodiment of the present invention, a computer readable medium storing a video display control interface is disclosed. The video display control interface may be downloaded into a display for video content display control, and the video is a combination of a first video content and a second video content. Moreover, the video display control interface includes an OSD menu providing a video display control item with at least a parameter setting field in response to the video display control item for adjusting the first and the second video content.

The preferred embodiments of the present invention reduce the costs in system environment establishing, maintaining such as the purchase of external media server and media box, training fee and salary of system administrator, and the disadvantages of indirect update and late response resulted from the prior art. In addition, it improves the real time efficiency through embedding and operating the video control item in the OSD.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of the digital signage display system according to the prior art.

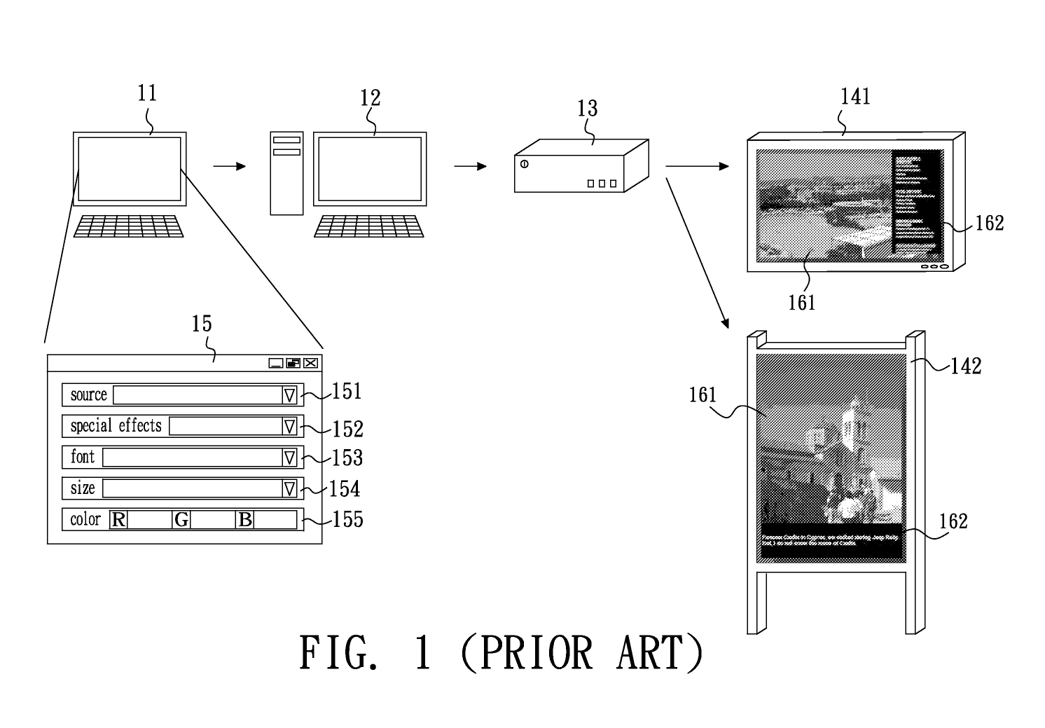

FIG. 2 is a diagram of the OSD of a display according to the prior art.

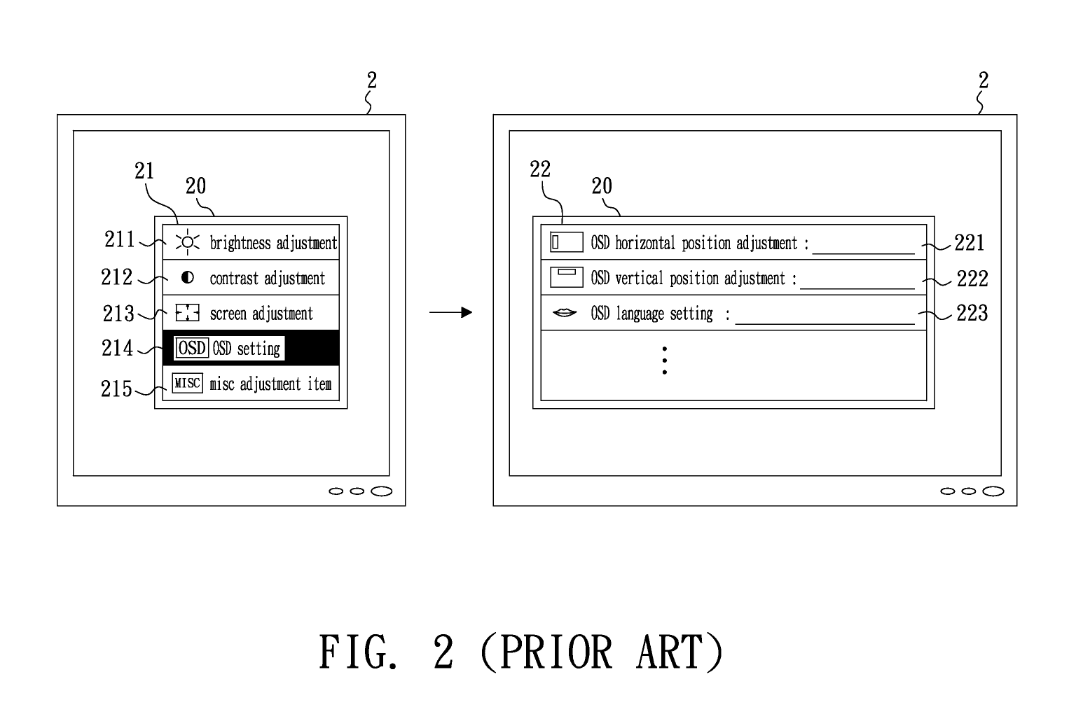

FIG. 3 is a flow chart of method for controlling video content display according to one embodiment of the present invention.

FIG. 4 is a diagram of display with video content display control according to one embodiment of the present invention.

FIG. 5 is a schematic diagram of display position of the second video content according to one embodiment of the present invention.

### DETAILED DESCRIPTION

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

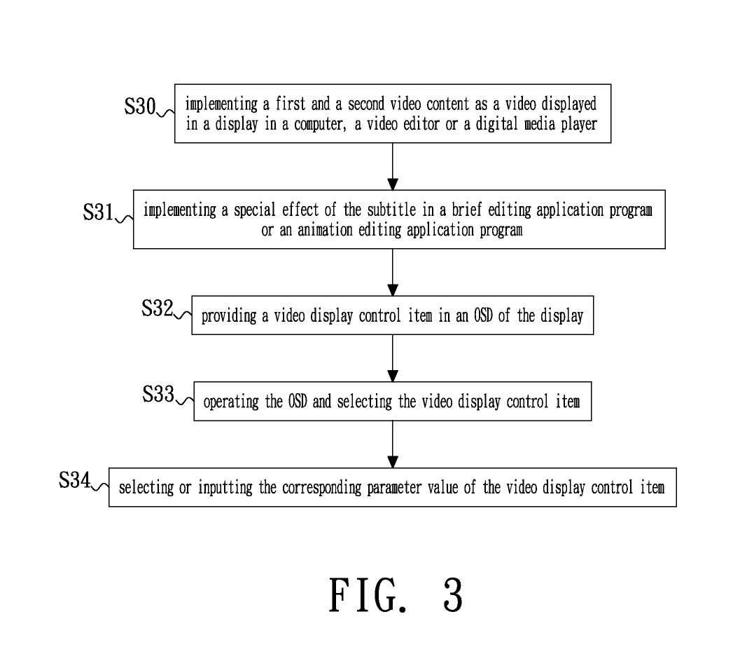

FIG. 3 is the flow chart of claimed method for controlling video content display. Accordingly, it implements a first and a second video content as a video displayed in a display in a computer, a video editor or a digital media player in step S30. Herein, the first and the second video content are static images or pictures, and the second video content is also one or more than one subtitle, slide show, a text ticker in response to the first video content for instance. Then, it implements a special effect of the subtitle in a brief editing application program or an animation editing application program such as Microsoft Powerpoint and Flash in step S31, provides a video display control item in an OSD of the display in step S32, operates the OSD and selects the video display control item in step S33. Till then, the display shows a parameter value inputting zone located at the same frame of the OSD or the video display control item or next frame of the OSD, and the user selects or inputs the corresponding parameter value of the parameter of the video display control item through a remote controller or a touchpad in step S34.

In addition, the parameter includes all or partial items of the group consisting of a display frame dividing type, a video source of each divided display frame, a display position of the second video content, an input source of the second video content, a display detection of the second video content, a switch effect of the second video content and a transparency of the second video content. In this preferred embodiment, the frame dividing type item includes the selection of the parameter value such as a PIP (picture in picture), a PBP (picture by picture) and a POP (picture on picture); the video source of each divided display frame item may be assigned by the first and the second video content to the main and the sub frame respectively; the display position of the second video content includes the selection of the parameter value such as a top side, a bottom side, a left side and a right side of the display; the input source of the second video content item includes the selection of the parameter value such as VGA, DVI and HDMI; the display detection of the second video content item includes the selection of the parameter value such as an off and an auto; the switch effect of the second video content includes the selection of the parameter value such as a fade in and fade out and video displayed from left to right; the transparency of the second video content item includes the selection of the parameter value such as value form 0% to 100% for displaying the first and the second video content in the display simultaneously or not. It's noted that the sequence of parameter values assignment and the species and the quantity of the parameter are up to the applications and may be built in.

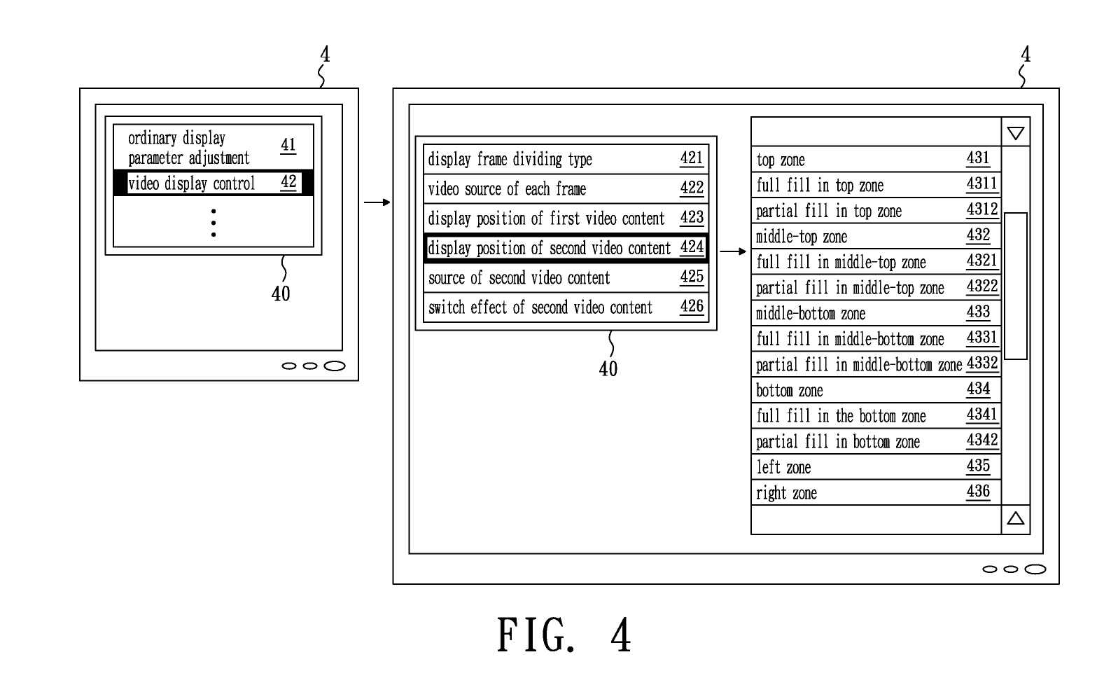

FIG. 4 is a diagram of display with video content display control according to one embodiment of the present invention. In the embodiment, a display 4 includes an OSD 40 having an ordinary display parameter adjustment item 41 and a video display control item 42 for setting display control of a video which is a combination of a first video content and a second video content. The OSD 40 consists of one or more than one parameter waiting to be set in response to the video display control item. In the embodiment, the parameter waiting to be set includes all or partial items of the group consisting of a display frame dividing type 421, a video source of each divided display frame 422, a display position of the first video content 423, a display position of the second video content 424, an input source of the second video content 425, and a switch effect of the second video content 426. The user may set the parameter waiting to be set and the parameter value in the same or a next frame of the OSD 40.

Moreover, the selections of the frame dividing type 421 and the video source of each divided display frame 422 determine which of the first and the second video content may be displayed in a main frame and a sub frame of a picture in picture (PIP), a picture by picture (PBP) or a picture on picture (POP). The display position of the first video content 423 and the display position of the second video content 424 determine the position allocation and size in the display 4. For example, when the position of the second video content 424 is selected, the OSD 40 provides a menu with the parameter values consisting of a top zone 431, a middle-top zone 432, a middle-bottom zone 433, a bottom zone 434, a full fill in the top zone 4311, a partial fill in the top zone 4312, a full fill in the middle-top zone 4321, a partial fill in the middle-top zone 4322, a full fill in the middle-bottom zone 4331, a partial fill in the middle-bottom zone 4332, a full fill in the bottom zone 4341, a partial fill in the bottom zone 4342, a left zone 435 and a right zone 436. In addition, the input source of the second video content 425 determines the input source such as VGA, DVI and HDMI, and the switch effect of the second video content 426 determines the parameter values such as the display and the switch effect of the first and the second video content in the display 4, and further the transparency of the second video content.

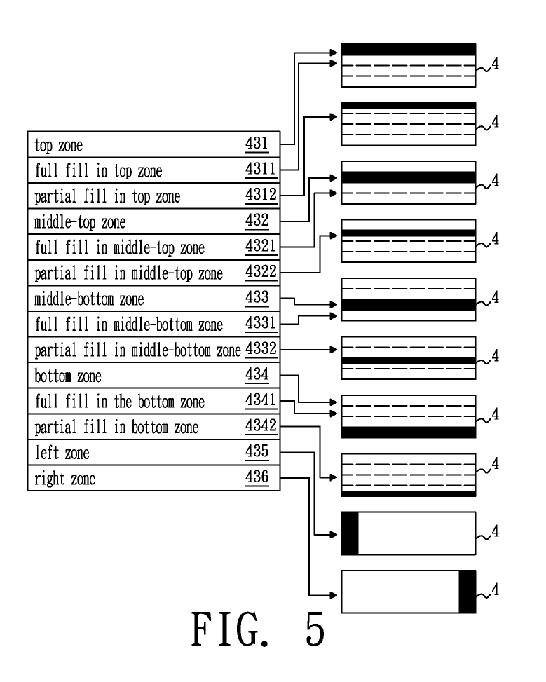

Furthermore, FIG. 5 shows a schematic diagram of display position of the second video content in response to the position of the second video content 424. Herein, the top zone 431 and a middle-top zone 432 indicate that the second video content is displayed in the top zone and the middle-top zone respectively, the full fill in the top zone 4311 indicates that the zone occupied by the second video content is the same area as that of the top zone 431, and the full fill in the top-middle zone 4321 indicates that the zone occupied by the second video content is the same area as that of the middle-top zone 432. The zone occupied by the second video content in the partial fill in the top zone 4312 is fractional to that of the top zone 431, and the partial fill in the middle-top zone 4322 is a fraction such as one half of the middle-top zone 432. Thus the corresponsive frame is shown as the highlighted black block of each display 4.

Again, the computer readable medium storing a video display control interface is disclosed. The video display control interface may be downloaded into a display for video content display control, and the video is a combination of a first and a second video content. Herein, the video display control interface has an OSD menu providing a video display control item with at least a parameter setting field in response to the video display control item for adjusting the first and the second video content. In addition, The parameter setting field in response to the video display control item may be displayed in a next frame of the OSD menu as well, and the parameter setting field includes all or partial items of the group consisting of a display frame dividing type, a video source of each divided display frame, a display position of the first video content, a display position of the second video content, an input source of the second video content, and a switch effect of the second video content. Therefore, the embodiments of present invention provide the advantages of reducing the costs in establishing and maintaining the system environment, such as the purchase of external media servers and media boxes, and training fee and salary of system administrator, and the disadvantages of indirect update and late response resulted from the prior art. In addition, the embodiments of present invention improve the real time efficiency through embedding and operating the video control item in the OSD.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for controlling video content display for accomplishing display control of a video in a display, wherein the video is a combination of a first video content and a second video content, the method comprising:
providing a video display control item in an on screen display of the display;
operating the on screen display and selecting the video display control item; and
setting a corresponding parameter value of a parameter of the video display control item to adjust the first video content and the second video content.

2. The method of claim 1, further comprising:
implementing the first video content and the second video content in a computer, a video editor or a digital media player.

3. The method of claim 1, wherein the second video content is a subtitle, the method further comprising:
implementing a special effect of a subtitle in a brief editing application program or an animation editing application program.

4. The method of claim 1, wherein the corresponding parameter value is set in a next frame of the on screen display.

5. The method of claim 1, wherein the parameter is selected from the group of a display frame dividing type, a video source of each divided display frame, a display position of the second video content, an input source of the second video content, a display detection of the second video content, a switch effect of the second video content and a transparency of the second video content.

6. The method of claim 1, wherein the parameter comprises:
a display frame dividing type;
a video source of each divided display frame;
a display position of the second video content;
an input source of the second video content;
a display detection of the second video content;
a switch effect of the second video content; and
a transparency of the second video content.

7. A display with video content display control, comprising:
an on screen display providing a video display control item for setting display control of a video, wherein the video is a combination of a first video content and a second video content.

8. The display of claim 7, wherein the on screen display further comprises:
at least a parameter waiting to be set in response to the video display control item for inputting a parameter value of the parameter waiting to be set.

9. The display of claim 8, wherein the parameter comprises at least one of a display frame dividing type, a video source of each divided display frame, a display position of the first video content, a display position of the second video content, an input source of the second video content, and a switch effect of the second video content.

10. The display of claim 8, wherein the parameter comprises:
a display frame dividing type;
a video source of each divided display frame;
a display position of the first video content;
a display position of the second video content;
an input source of the second video content; and
a switch effect of the second video content.

11. The display of claim 7, wherein the on screen display further comprises a parameter waiting to be set in response to the video display control item, and a next frame of the on screen display is provided for inputting a parameter value of the parameter waiting to be set.

12. The display of claim 11, wherein the parameter comprises at least one of a display frame dividing type, a video source of each divided display frame, a display position of the first video content, a display position of the second video content, an input source of the second video content, and a switch effect of the second video content.

13. The display of claim 11, wherein the parameter comprises:
a display frame dividing type;
a video source of each divided display frame;
a display position of the first video content;
a display position of the second video content;
an input source of the second video content; and
a switch effect of the second video content.

14. A computer readable medium storing a video display control interface for downloading into a display and controlling display of a video, wherein the video is a combination of a first video content and a second video content, the video display control interface comprising:
an on screen display menu providing a video display control item with at least a parameter setting field in response to the video display control item for adjusting the first video content and the second video content.

15. The computer readable medium of claim 14, wherein the parameter setting field comprises at least one of a display frame dividing type, a video source of each divided display frame, a display position of the first video content, a display position of the second video content, an input source of the second video content, and a switch effect of the second video content.

16. The computer readable medium of claim 14, wherein the parameter setting field comprises:
a display frame dividing type;
a video source of each divided display frame;
a display position of the first video content;
a display position of the second video content;
an input source of the second video content; and
a switch effect of the second video content.

17. The computer readable medium of claim 14, wherein a next frame of the on screen display menu provides the parameter setting field in response to the video display control item.

18. The computer readable medium of claim 17, wherein the parameter setting field comprises one of a display frame dividing type, a video source of each divided display frame, a display position of the first video content, a display position of the second video content, an input source of the second video content, and a switch effect of the second video content at least.

19. The computer readable medium of claim 17, wherein the parameter setting field comprises:
a display frame dividing type;
a video source of each divided display frame;
a display position of the first video content;
a display position of the second video content;
an input source of the second video content; and
a switch effect of the second video content.
